(19) United States
(12) Patent Application Publication
(10) Pub. No.: US 2012/0031090 A1
(43) Pub. Date: Feb. 9, 2012

(54) CIRCULAR MOVEMENT ELECTRICITY GENERATING MACHINE

(76) Inventor: Mario Teixeira Cavalheiro, Santos (BR)

(21) Appl. No.: 13/133,760

(22) PCT Filed: Dec. 16, 2010
(86) PCT No.: PCT/BR10/00441

§ 371 Date: Jun. 9, 2011

(30) Foreign Application Priority Data
Jan. 28, 2010 (BR) PI 1000231-6
Jun. 24, 2010 (BR) PI 1001777-1

(51) Int. Cl. F03B 13/00; H02N 11/00; F03G 7/10

(52) U.S. Cl. 60/504; 74/DIG. 9

(57) ABSTRACT

Hydraulic strength machine in circular movement generating electricity in two different generation spots and mechanical strength machine in circular movement generating electricity, being that that the hydraulic strength machine in circular movement generating electricity in two different generation spots 33 operates by hydraulic principle comprising tubes (2), (3), (4) and (5), and inside each one a float (44) is provided, which drags cables connected to a transmission system connected in its turn to generators (25) and (57), said tubes (2), (3), (4) and (5) being mounted on a frame which rotates driven by an electric engine (8). The alternative version of the machine here discussed, which is defined as a mechanical strength machine in circular movement generating electricity provides a central wheel (73) placed on the axle (59) embedded in two movable bearings (60) and (61), on such axle (59) two pulleys (62) and (63) are supported, pulleys which convey the circular movement, the pulleys (66) and (67) placed on the axle (68) where the pulley (69) is located, pulley which drives its movement to generator (72); the wheel (73) is supported on two pulleys (74) and (75) which receive the stress of the electric engine (77) through a chain (76).

### BACKGROUND OF THE INVENTION

1. Field of the Invention

The present application refers to a hydraulic strength machine in circular movement generating electricity in two different generation spots. Another aspect covered by this application is an alternative version of said machine, which is called a mechanical strength machine in circular movement generating electricity, which is operated purely by mechanical principles.

2. Description of the Related Art

No prior art references exist, to the best of the Applicant's knowledge, for the generation of electrical energy using the principles disclosed and claimed herein.

### SUMMARY OF THE INVENTION

The hydraulic strength machine in circular movement generating electricity in two different generation spots is configured as a machine intended to generate electricity, which has been fully developed and automated to generate power in two different generation spots.

With the motor 8 below the circular wheel 1 which supports the machine weight placed on two rollers 53 and 54, the same, while rotating, move the wheel 1 and the axle 43, a pulley 14 is placed on such axle, which absorbs the axle 43 movement and transfers it to the generator 57 supported on the mobile table 58, finishing the first electricity generation spot in low rotation.

The present patent covers further a variation of the same kind of power generating machine, which, different from the first model which adopts hydraulic principles, is based purely on mechanical principles.

The alternative version of the machine now discussed, which is defined as a power mechanical machine of circular movement generating electricity, counts on two pulleys and one central wheel or more bigger than the pulleys supported by a mobile central axle and two bearings, transferring the central movement along with its weight to two pulleys driven by an electric engine and transferring such movement to the electric generator.

Further objects of the invention will be brought out in the following part of the specification, wherein detailed description is for the purpose of fully disclosing the invention without placing limitations thereon.

### BRIEF DESCRIPTION OF THE DRAWINGS

The present invention, as regards the two variations of the machine here discussed, may be fully understood through the detailed description, which shall be done based on the figures listed below, in which:

FIG. 1 shows an embodiment for the hydraulic machine subject of the present application viewed from its side with more than one electricity generation spot in different rotation;

FIG. 2 shows, also in relation to the hydraulic machine, only one pipe and how the steel cables are wound up and wound off during automatic movement transfer to the outside of tubes; and

FIG. 3 shows a front view of an alternate version of the invention.

### DETAILED DESCRIPTION OF THE EMBODIMENTS OF THE INVENTION

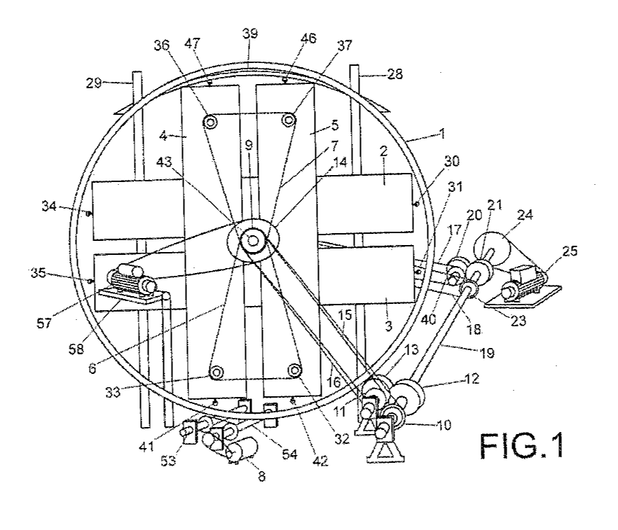

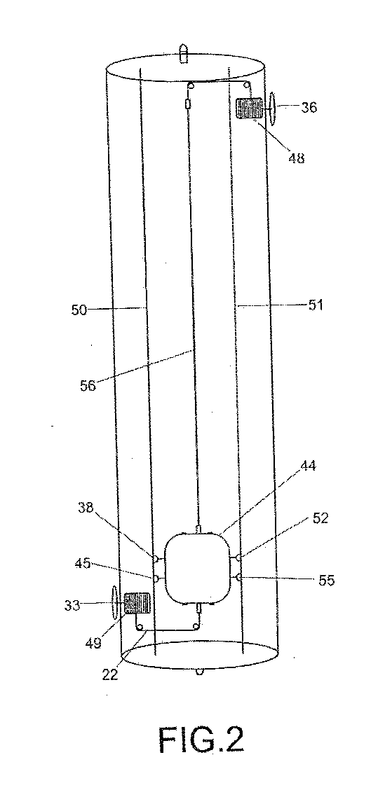

FIG. 1 displays the first machine configuration here discussed, which operates through hydraulic principles and is made up by circular wheel 1, where the machine weight is transferred to two rollers 53 and 54, tubes full of water 2, 3, 4 and 5, where the floats 44 move. When the float 44 of FIG. 2 rises, it moves the cable 22 inside the tube, and such cable 22 is wound off from the pulley 49 and movements the external gears 32, 33 and 9.

Another chain derives from such gear 9 towards the mechanical chain gear with movement of the mechanical chain gear with movement of the ratchet attached 10, such movement is transferred to the axle 19 and the first automatic movement is carried out upon generator 25 rotation. Here the second generation spot takes place in high rotation.

When the float moves, the pulley 48 cable 56 is wound up. The cable of pulley 49 winds off The movement of pulley cable, which winds off 49, rotates the gear 9 and in turn moves the gears 36 and 37 and the pulley of both tubes, which winds up the steel cable 56 movements and winds up the cable and turns everything ready for the next float rise, as soon as the tubes exceed the horizontal line the next rise is carried out and so the second automation is carried out. It must be noted that the first and second automation were originated, however, during the second tube run the movement towards axle 19 of generator 25 rotates reverted because the cables move differently and then it is possible to place another chain in gear 9 to the opposite direction, not to the ratchet 10 attached, but to the gear 11, as shown in the drawing, gear 11 moves gear 12 with the ratchet attached and transfers the movement to axle 19, it was possible to maintain the machine always in the same rotation direction in relation to axle 19 in movement to generator 25.

The machine drawing is seen from the side, these movements here described take place in tubes 4 and 5, therefore, tubes 2 and 3 also have the same number of gears, the same movements, the same ratchets, the same steel cables, floats and their respective movements similar to the description of tubes 4 and 5, but you do not see the opposite side in the drawing, but it is precisely the same that you see in the drawing. The following numbers appear: 23 gear with ratchet towards the axle 43, mechanical chain 17, gear 20, gear 21 with ratchet attached, mechanical gear 40, power generator 25, pulley with chain attached 24, air opening valves 30, 31, 34, 35, 41, 42, 46 and 47 to allow the movement of floats which are opened during the machine rotation while passing through the circular ruler 39. The machine supporting assembly made up by two rollers 53 and 54, three chain gears duly attached and a small electric engine 8 comprise the whole machine supporting assembly and the nm of such small engine allows the tube rotation which enables the tube movement where the floats are embedded. Balance tubes in the machine construction 28 and 29, axle 43 of machine central support with two movable bearings in the vertical direction which allows the machine to rotate totally supported by rollers 53 and 54.

Since axle 43 becomes movable and the weight of two rollers allow us to place a pulley 17 on the machine axle 43, such movement is driven to an electric generator 57, such generator is placed on a movable table 58 to allow that its weight is also transferred to the rollers 53 and 54 of such machine, which makes the movement easier and high power generation. Such transfer enables to generate power in low rotation, which comprises the first generation spot.

FIG. 2 displays the float 44 operation inside each tube of this machine The display is done with only one tube containing the pulleys 48 and 49 inside, when the float 44 raises the pulley 49 where the cable is wound up, it winds off and its movement is transferred to the external gears 32 and 33 of two tubes and at the same time rotate the external gear 9 which in its turn transfer the movement to gears 36 and 37 external to both tubes, such gears rotate the internal pulley 48 which Wind up the cable inside the tube finishing the full winding up and winding off of the cable. It must be noted that all movements start from the float rise and that the movement transfer is reversed in each end of the tubes, which is why the ratchets revert the movements during machine automation so that all float movements are reutilized.

The spots 38, 45, 52, 55 are small rollers which rotate along with the float upon rise through tubes 50 and 51.

It must be noted that gear 9 has four chains, chain 6 derives from gears 32 and 33, and ends in gear 9, another chain 7 derives from gears 36 and 37 and ends in gear 9, another chain 15 derives from gear 9 and follows to gear with ratchet 10, another chain 16 derives from gear 9 and follows to gear 11. All movements are also repeated in the machine opposite side viewed laterally.

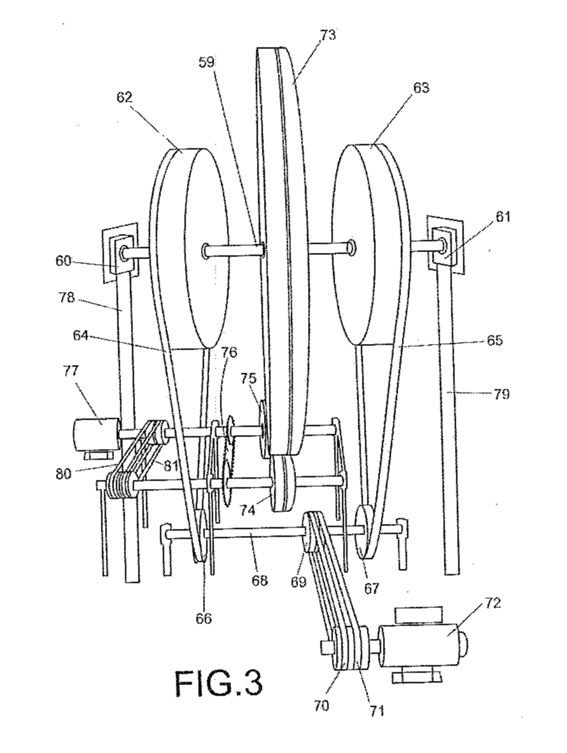

The alternative version of the machine here proposed, and displayed in FIG. 3, comprises a central axle 59 placed in two movable bearings 60 and 61, where two pulleys are placed in a big spot 62 and 63 which transfer their movement through chains 64 and 65, the pulleys 66 and 67 placed on axle 68, where pulley 69 is placed, which will rotate generator 72 through chains 70 and 71 in the central axle 59. There is a bigger wheel 73 supported on the smaller pulleys 74 and 75, pulled by a mechanical chain 76 by an electrical engine 77. When such engine rotates and the pulleys 74 and 75 movement there is a large difference of strength to rotate the machine supported and with its result it is possible obtain meaningful strength which results in the construction of a perfect electricity generating machine already in full operation. Holding support 78 and holding support 79. Electrical engine chains 80 and 81.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. Power hydraulic machine of circular movement generating electricity in two different generation spots, which is a machine fully developed to generate electricity totally automated, characterized by the fact that it comprises two different power generation spots, one with low rotation and another with high rotation; the low rotation occurs with the drive of an electric engine (8) below the circular wheel (1) with the machine weight supported in two rollers (53) and (54), which rotate the axle (43) which in its turn a pulley (14) is placed on this axle, it absorbs the movement of axle (43) and transfers it to the low rotation generator (57), finishing the first generation spot; the second spot is carried out by the float movement inside the tubes (2), (3), (4) and (5) fully automated with the float rise movement, while passing a little below the horizontal line the floats start to rise and the first movement of floats occurs and the pulley (49) winds off, the steel cable (22) pulled by the float (44) transfers the movement to gears (32), (33) and (9), and from gear (9) the chain moves to gear (10) towards axle (19) and drives the generator (25) during rotation, finishing a portion of float movement; the movement of gear (9) carried out by internal pulley (49) at the same winds up the pulley (48) which transfer the movement to gears (36) and (37) and the automatic movement of steel cable (56) winding up was carried out, but the external movement of gears (36) and (37) was reverted;
it is necessary to change the ratchet (12) movement, from gear (9) another chain is derived towards gear (11) which in its turn rotated gear (13) and transferred the movement to gear (12) with ratchet, finishing the second automatic movement of float movements and total transfer of movement towards the generator (25), second electricity generation spot, but in high rotation; this machine has as main and outstanding spot the movement of rollers (53) and (54) on which the machine is supported; the axle where the first generation spot (43) rotates drives the machine without any stop during transfer to generator (25) movement carried out by the floats where the second generation spot in high speed occurs; I claim also the gear (9) which has four passages of chains, the chain (6) derives from gears (32) and (33), ends in gear (9), another chain (7) derives from gears (36) and (37) ends in gear (9), another chain (15) derives from gear (9) proceeds to gear with ratchet (10), another chain (16) derives from gear (9) proceeds to gear (11); all such movements are repeated also on the opposite side of the machine since they are already repeated on the opposite side of the machine when viewed laterally.

2. Mechanical strength machine in circular movement generating electricity, which is a machine totally developed to generate electricity, characterized by the machine movement to be carried out on the support of the central wheel (73) placed on axle (59) embedded in two movable bearings (60) and (61), and two pulleys (62) and (63) are based on such axle (59), pulleys which convey the circular movement, the pulleys (66) and (67) placed on axle (68) where the pulley (69) is located which drives its movement to the generator (72); the wheel (73) is supported on two pulleys (74) and (75) which receive the stress of the electricity (77) through a chain (76) and with the stress of such engine and with the central wheel in movement supported on the pulleys (74) and (75) it is possible to obtain strength that allows us to generate electricity in large quantity since it is the movement of pulleys in different circles and with different ranges that is why all movements of such power generation machine, already in full operation are claimed.
